(19) United States
(12) Patent Application Publication
(10) Pub. No.: US 2013/0093875 A1
(43) Pub. Date: Apr. 18, 2013

(54) SYSTEMS AND METHODS ASSOCIATED IN FISHING FOR DETECTING EXISTENCE OF WARM-BLOODED FISH

(71) Applicant: TAI CHEUNG POON, Hong Kong (HK)

(72) Inventor: TAI CHEUNG POON, Hong Kong (HK)

(21) Appl. No.: 13/275,548

(22) Filed: Oct. 18, 2011

(51) Int. Cl. H04N 7/18

(52) U.S. Cl. 348/81; 348/E07.085

(57) ABSTRACT

Systems for making a toy more comfortable are provided. In one embodiment, a system is provided, including a toy including a body and a hand, wherein the toy's temperature is adjustable; an infrared tracking device used to wirelessly detect an amount of heat radiating from a remote object including a human being, wherein the tracking device is included in the toy; a laser-based distance measuring device included in the toy; a temperature tracking device in the toy used to measure a room temperature; a first heater included in the body of the toy; a second heater included in the hand of the toy; a first cooler included in the body of the toy; and a second cooler included in the hand of the toy.

### FIELD OF THE INVENTION

This invention generally relates to methods for detecting existence of certain fish. Specially, but not limited to, this invention relates to detecting existence of warm-blooded fish. More, this invention uses sonic technology as a means of communication between underwater and above water devices.

### BACKGROUND OF THE INVENTION

Most fish species are cold-blooded. Specifically, the body temperatures of most of the fish species are very close to the temperature of the water where they reside. However, a small number of fish species are warm-blooded. These fish species have body temperatures typically a few centigrade degrees higher than normal fish. Such fish species include Tuna and certain species of shark carry these characteristics. Coincidentally, the commercial value of these fish species is very high. Therefore, means to detect existence of these high-value fish species are highly desired. With the advocate of those from the information technology industry, the fishing technology can leverage technologies to increase efficiency and productivity of fishing. For example, the fisherman may look at past data to determine behavior of certain fish at different locations at different times. Also, the fishing industry is very susceptive to seasonal fluctuations. In other words, at different times of a season, fish may appear or disappear in different locations. Therefore, the ability to look at behavior of the fishing species can be highly rewarding to the fishermen. In view of the foregoing, there is a need to systematically collect information from living organisms in the sea.

### SUMMARY OF THE INVENTION

A system associated in fishing for a feature detecting existence of warm-blooded fish including Tuna, comprising: a control device, wherein the device is being associated with a boat; a upper housing, as part of the device, floats onto water; a lower housing that is detachable from the device through a physical link, wherein the lower housing is configured to submerge deep into the water, for purposes of detecting existence of the warm-blooded fish; a locator included in the upper housing of the device that can identify a location where the warm-blooded fish is found; an infrared sensor attached to the lower housing, wherein the sensor is configured to detect the warm-blooded fish based on a higher temperature detected, in comparison with other types of cool-blooded fish, whose temperatures are usually lowered; an acoustic transponder physically attached to the upper housing, wherein the acoustic transponder reports the existence of the warm-blooded fish upon detection by the lower housing; an acoustic transducer physically attached to the lower housing, wherein the acoustic transducer is configured to receive notifications from the lower housing; a camera is configured to be physically attached to the lower housing, wherein the camera is used to confirm the existence of warm-blooded fish detected by the infrared sensor; a temperature reader included in the lower housing to detect water temperature; a processing unit configured to execute a set of instructions; and a memory unit storing instructions that cause the processing unit to execute the instructions.

In one embodiment, the system may include a method that comprises initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; and if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; and combining the current location and the photograph before sending the notification to the control device.

In another embodiment, the system's embodied method may comprises initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; combining the current location and the photograph before sending the notification to the control device; noting to the electronic map that a warm-blooded fish is found at the current location; and continuing the detection of existence of warm-blooded fish at other locations, after the boat moves to the other locations, wherein: existence of the other warm-blooded fish at other locations will be recorded in the electronic map, allowing others to query, at a later time, that: whether a given location has any warm-blooded fish; and to visualize, through a UI, an entire population of warm-blooded fish of a geographic area, based on information of the electronic map.

In another alternate embodiment, the system may include a method that comprises initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; combining the current location and the photograph before sending the notification to the control device; noting to the electronic map that a warm-blooded fish is found at the current location; and continuing the detection of existence of warm-blooded fish at other locations, after the boat moves to the other locations, wherein: existence of the other warm-blooded fish at same location will be recorded in the electronic map, allowing others to query, at a later time, that: seasonal changes of the existence of the warm-blooded fish at the current location; and to visualize, through a UI, an entire population of warm-blooded fish of a geographic area, based on information of the electronic map.

### BRIEF DESCRIPTION OF THE DRAWINGS

FIG. 1 illustrates an exemplary system to make detecting warm-blooded fish system.

### DETAILED DESCRIPTION

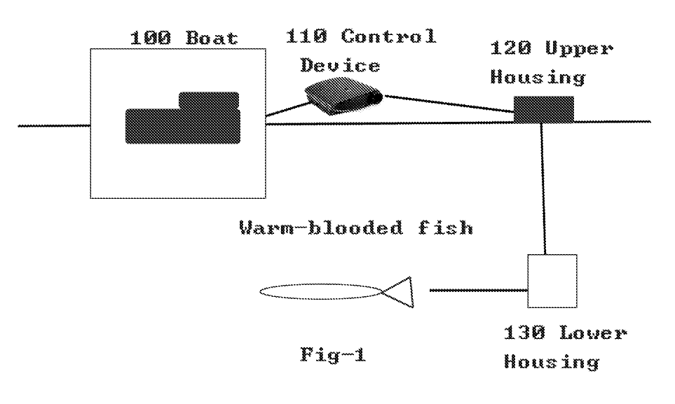

Referring to FIG. 1, a system associated in fishing for a feature detecting existence of warm-blooded fish is disclosed. The disclosed system includes a control device, wherein the device is being associated with a boat; a upper housing, as part of the device, floats onto water; a lower housing that is detachable from the device through a physical link, wherein the lower housing is configured to submerge deep into the water, for purposes of detecting existence of the warm-blooded fish; a locator included in the upper housing of the device that can identify a location where the warm-blooded fish is found; an infrared sensor attached to the lower housing, wherein the sensor is configured to detect the warm-blooded fish based on a higher temperature detected, in comparison with other types of cool-blooded fish, whose temperatures are usually lowered; an acoustic transponder physically attached to the upper housing, wherein the acoustic transponder reports the existence of the warm-blooded fish upon detection by the lower housing; an acoustic transducer physically attached to the lower housing, wherein the acoustic transducer is configured to receive notifications from the lower housing; a camera is configured to be physically attached to the lower housing, wherein the camera is used to confirm the existence of warm-blooded fish detected by the infrared sensor; a temperature reader included in the lower housing to detect water temperature; a processing unit configured to execute a set of instructions; and a memory unit storing instructions that cause the processing unit to execute the instructions, comprising: initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; and if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; and combining the current location and the photograph before sending the notification to the control device.

In another disclosure, the system associated in fishing for a feature detecting existence of warm-blooded fish includes a control device, wherein the device is being associated with a boat; a upper housing, as part of the device, floats onto water; a lower housing that is detachable from the device through a physical link, wherein the lower housing is configured to submerge deep into the water, for purposes of detecting existence of the warm-blooded fish; a locator included in the upper housing of the device that can identify a location where the warm-blooded fish is found; an infrared sensor attached to the lower housing, wherein the sensor is configured to detect the warm-blooded fish based on a higher temperature detected, in comparison with other types of cool-blooded fish, whose temperatures are usually lowered; an acoustic transponder physically attached to the upper housing, wherein the acoustic transponder reports the existence of the warm-blooded fish upon detection by the lower housing; an acoustic transducer physically attached to the lower housing, wherein the acoustic transducer is configured to receive notifications from the lower housing; a camera is configured to be physically attached to the lower housing, wherein the camera is used to confirm the existence of warm-blooded fish detected by the infrared sensor; a temperature reader included in the lower housing to detect water temperature; an electronic map, wherein the map is configured to store information regarding population of the warm-blooded fish at different locations; a processing unit configured to execute a set of instructions; and a memory unit storing instructions that cause the processing unit to execute the instructions, comprising: initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; combining the current location and the photograph before sending the notification to the control device; noting to the electronic map that a warm-blooded fish is found at the current location; and continuing the detection of existence of warm-blooded fish at other locations, after the boat moves to the other locations, wherein: existence of the other warm-blooded fish at other locations will be recorded in the electronic map, allowing others to query, at a later time, that: whether a given location has any warm-blooded fish; and to visualize, through a UI, an entire population of warm-blooded fish of a geographic area, based on information of the electronic map.

Further in the disclosure, the disclosed device is being associated with a boat; a upper housing, as part of the device, floats onto water; a lower housing that is detachable from the device through a physical link, wherein the lower housing is configured to submerge deep into the water, for purposes of detecting existence of the warm-blooded fish; a locator included in the upper housing of the device that can identify a location where the warm-blooded fish is found; an infrared sensor attached to the lower housing, wherein the sensor is configured to detect the warm-blooded fish based on a higher temperature detected, in comparison with other types of cool-blooded fish, whose temperatures are usually lowered; an acoustic transponder physically attached to the upper housing, wherein the acoustic transponder reports the existence of the warm-blooded fish upon detection by the lower housing; an acoustic transducer physically attached to the lower housing, wherein the acoustic transducer is configured to receive notifications from the lower housing; a camera is configured to be physically attached to the lower housing, wherein the camera is used to confirm the existence of warm-blooded fish detected by the infrared sensor; a temperature reader included in the lower housing to detect water temperature; an electronic map, wherein the map is configured to store information regarding population of the warm-blooded fish at different locations; a processing unit configured to execute a set of instructions; and a memory unit storing instructions that cause the processing unit to execute the instructions, comprising: initializing the feature of detecting the existence of warm-blooded fish; dropping the device onto the water; separating the upper housing from the lower housing to allow the upper housing float onto the water while the upper housing sink to bottom of the water; enabling the infrared sensor to detect a temperature of a living creature at current location; measuring current water temperature by the temperature reader; if the temperature of the living creature is similar to the water temperature, ignoring the living creature; if the temperature of the living creature is higher to the water temperature, carrying out a set of steps, wherein the steps include: taking a photograph by using the camera to confirm that the nature of the living creature is the warm-blooded fish; using the acoustic transducer to report the existence of the warm-blooded fish, wherein the report includes the photograph for confirming whether the nature of the living creature is the warm-blooded fish; after receiving the notification from the acoustic transponder about the existence of the warm-blooded fish, identifying a current location by the locator included in the upper housing, in order to identify the location where the warm-blooded fish is found; combining the current location and the photograph before sending the notification to the control device; noting to the electronic map that a warm-blooded fish is found at the current location; and continuing the detection of existence of warm-blooded fish at other locations, after the boat moves to the other locations, wherein: existence of the other warm-blooded fish at same location will be recorded in the electronic map, allowing others to query, at a later time, that: seasonal changes of the existence of the warm-blooded fish at the current location; and to visualize, through a UI, an entire population of warm-blooded fish of a geographic area, based on information of the electronic map.

What is claimed is:

1. A system associated in fishing for a feature detecting existence of warm-blooded fish including Tuna, comprising:
a control device, wherein the device is being associated with a boat;
a upper housing, as part of the device, floats onto water;
a lower housing that is detachable from the device through a physical link, wherein the lower housing is configured to submerge deep into the water, for purposes of detecting existence of the warm-blooded fish;
a locator included in the upper housing of the device that can identify a location where the warm-blooded fish is found;
an infrared sensor attached to the lower housing, wherein the sensor is configured to detect the warm-blooded fish based on a higher temperature detected, in comparison with other types of cool-blooded fish, whose temperatures are usually lowered;
an acoustic transponder physically attached to the upper housing, wherein the acoustic transponder reports the existence of the warm-blooded fish upon detection by the lower housing;
an acoustic transducer physically attached to the lower housing, wherein the acoustic transducer is configured to receive notifications from the lower housing;
a camera is configured to be physically attached to the lower housing, wherein the camera is used to confirm the existence of warm-blooded fish detected by the infrared sensor;
a temperature reader included in the lower housing to detect water temperature;
a processing unit configured to execute a set of instructions; and
a memory unit storing instructions that cause the processing unit to execute the instructions.

2. The system of claim 1, wherein the method comprises:
initializing the feature of detecting the existence of warm-blooded fish;
dropping the device onto the water;
separating the upper housing from the lower housing to allow the upper housing float onto the water while the upper housing sink to bottom of the water;
enabling the infrared sensor to detect a temperature of a living creature at current location;
measuring current water temperature by the temperature reader;
if the temperature of the living creature is similar to the water temperature, ignoring the living creature; and
if the temperature of the living creature is higher to the water temperature, carrying out a set of steps, wherein the steps include:
taking a photograph by using the camera to confirm that the nature of the living creature is the warm-blooded fish;
using the acoustic transducer to report the existence of the warm-blooded fish, wherein the report includes the photograph for confirming whether the nature of the living creature is the warm-blooded fish;
after receiving the notification from the acoustic transponder about the existence of the warm-blooded fish,
identifying a current location by the locator included in the upper housing, in order to identify the location where the warm-blooded fish is found; and
combining the current location and the photograph before sending the notification to the control device.

3. The system of claim 1, wherein the method comprises:
initializing the feature of detecting the existence of warm-blooded fish;
dropping the device onto the water;
separating the upper housing from the lower housing to allow the upper housing float onto the water while the upper housing sink to bottom of the water;
enabling the infrared sensor to detect a temperature of a living creature at current location;
measuring current water temperature by the temperature reader;
if the temperature of the living creature is similar to the water temperature, ignoring the living creature;
if the temperature of the living creature is higher to the water temperature, carrying out a set of steps, wherein the steps include:
taking a photograph by using the camera to confirm that the nature of the living creature is the warm-blooded fish;
using the acoustic transducer to report the existence of the warm-blooded fish, wherein the report includes the photograph for confirming whether the nature of the living creature is the warm-blooded fish;
after receiving the notification from the acoustic transponder about the existence of the warm-blooded fish,
identifying a current location by the locator included in the upper housing, in order to identify the location where the warm-blooded fish is found;
combining the current location and the photograph before sending the notification to the control device;
noting to the electronic map that a warm-blooded fish is found at the current location; and
continuing the detection of existence of warm-blooded fish at other locations, after the boat moves to the other locations, wherein:
existence of the other warm-blooded fish at other locations will be recorded in the electronic map, allowing others to query, at a later time, that:
whether a given location has any warm-blooded fish; and
to visualize, through a UI, an entire population of warm-blooded fish of a geographic area, based on information of the electronic map.

4. The system of claim 1, wherein the method comprises:
initializing the feature of detecting the existence of warm-blooded fish;
dropping the device onto the water;
separating the upper housing from the lower housing to allow the upper housing float onto the water while the upper housing sink to bottom of the water;
enabling the infrared sensor to detect a temperature of a living creature at current location;
measuring current water temperature by the temperature reader;
if the temperature of the living creature is similar to the water temperature, ignoring the living creature;
if the temperature of the living creature is higher to the water temperature, carrying out a set of steps, wherein the steps include:
taking a photograph by using the camera to confirm that the nature of the living creature is the warm-blooded fish;
using the acoustic transducer to report the existence of the warm-blooded fish, wherein the report includes the photograph for confirming whether the nature of the living creature is the warm-blooded fish;
after receiving the notification from the acoustic transponder about the existence of the warm-blooded fish,
identifying a current location by the locator included in the upper housing, in order to identify the location where the warm-blooded fish is found;
combining the current location and the photograph before sending the notification to the control device;
noting to the electronic map that a warm-blooded fish is found at the current location; and
continuing the detection of existence of warm-blooded fish at other locations, after the boat moves to the other locations, wherein:
existence of the other warm-blooded fish at same location will be recorded in the electronic map, allowing others to query, at a later time, that:
seasonal changes of the existence of the warm-blooded fish at the current location; and
to visualize, through a UI, an entire population of warm-blooded fish of a geographic area, based on information of the electronic map.
